(19) United States
(12) Patent Application Publication
(10) Pub. No.: US 2013/0229960 A1
(43) Pub. Date: Sep. 5, 2013

(54) METHODS AND DEVICES FOR FACILITATING TRANSMITTER CIRCUIT POWER REGULATION

(71) Applicants: Debesh Kumar Sahu, Hyderabad (IN); Venkata Siva Prasad Gude, Hyderabad (IN); Bhaskara V. Batchu, Hyderabad (IN)

(72) Inventors: Debesh Kumar Sahu, Hyderabad (IN); Venkata Siva Prasad Gude, Hyderabad (IN); Bhaskara V. Batchu, Hyderabad (IN)

(73) Assignee: Qualcomm Incorporated, San Diego, CA (US)

(21) Appl. No.: 13/598,224

(22) Filed: Aug. 29, 2012

Related U.S. Application Data
(60) Provisional application No. 61/564,228, filed on Nov. 28, 2011.

(51) Int. Cl. H04W 52/02

(52) U.S. Cl. CPC H04W 52/0274
USPC 370/311

(57) ABSTRACT

Access terminals are adapted to facilitate power regulation of a transmitter circuit by employing a transmitter power timer. An access terminal may identify expiration of a predetermined period of time without any data to be sent. The access terminal may subsequently power down the transmitter circuit in response to the expiration of the predetermined period of time. Methods for facilitating power regulation of a transmitter circuit include initiating a transmitter power timer after a data transmission, and powering off the transmitter circuit when the transmitter power timer expires without data to be transmitted. The transmitter power timer can be adapted to facilitate guarantee frames for smart blanking, and can operate independent of a dormancy timer. Other aspects, embodiments, and features are also included.

### CLAIM OF PRIORITY UNDER 35 U.S.C. §119

The present application for patent claims priority to Provisional Application No. 61/564,228 entitled “METHODS AND DEVICES FOR FACILITATING TRANSMITTER CIRCUIT POWER REGULATION” filed Nov. 28, 2011, and assigned to the assignee hereof and hereby expressly incorporated by reference herein.

### TECHNICAL FIELD

The following relates generally to wireless communication, and more specifically to methods and devices for facilitating transmitter circuit power regulation in access terminals.

### BACKGROUND

Wireless communications systems are widely deployed to provide various types of communication content such as voice, video, packet data, messaging, broadcast, and so on. These systems may be accessed by various types of access terminals adapted to facilitate wireless communications, where multiple access terminals share the available system resources (e.g., time, frequency, and power). Examples of such wireless communications systems include code-division multiple access (CDMA) systems, time-division multiple access (TDMA) systems, frequency-division multiple access (FDMA) systems and orthogonal frequency-division multiple access (OFDMA) systems.

Access terminals adapted to access one or more wireless communications systems are becoming increasingly popular, with consumers often using power-intensive applications that run on the access terminals. Access terminals are typically battery-powered and the amount of power a battery can provide between charges is generally limited.

### BRIEF SUMMARY OF SOME EXAMPLES

As various types of access terminals typically operate on a rechargeable battery, features which may assist in extending the operating life of the access terminal between recharging are therefore beneficial. Various examples and implementations of the present disclosure facilitate power conservation by regulating power consumption at a transmitter circuit. One or more aspects of the present disclosure include access terminals adapted to regulate power at a transmitter circuit. In at least one example, such access terminals may include a communications interface and a storage medium. The communications interface can include the transmitter circuit. The communications interface and the storage medium can be coupled with a processing circuit. The processing circuit may be adapted to identify expiration of a predetermined period of time without any data to be sent via the transmitter circuit. In response to the expiration of the predetermined period of time, the processing circuit may be adapted to power down the transmitter circuit.

Additional aspects of the present disclosure include methods operational on an access terminal and/or access terminals including means for performing such methods. One or more examples of such methods may include initiating a transmitter power timer following a data transmission. A determination may be made that the transmitter power timer has expired without data to be transmitted. In response to the expiration of the transmitter power timer, a transmitter circuit may be powered OFF.

Further aspects of the present disclosure include computer-readable mediums including programming for identifying expiration of a transmitter power timer without data to be transmitted. Programming may also be included for powering down a transmitter circuit in response to the expiration of the transmitter power timer.

Other aspects, features, and embodiments associated with the present disclosure will become apparent to those of ordinary skill in the art upon reviewing the following description in conjunction with the accompanying figures.

### DRAWINGS

FIG. 1 is a block diagram illustrating an example of a network environment in which one or more aspects of the present disclosure may find application.

FIG. 2 is a block diagram illustrating an example of a protocol stack architecture which may be implemented by an access terminal.

FIG. 3 is a block diagram illustrating a frame sequence in a conventional access terminal during the duration of a dormancy timer, according to at least one example.

FIG. 4 is a block diagram illustrating select components of an access terminal according to at least one example.

FIG. 5 is a block diagram illustrating an operational frame sequence in an access terminal according to at least one example.

FIG. 6 (including FIGS. 6A and 6B) is a flow diagram illustrating a method operational on an access terminal according to at least one example.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of telecommunication systems, network architectures, and communication standards. Certain aspects of the discussions are described below for CDMA and 3rd Generation Partnership Project 2 (3GPP2) 1× protocols and systems, and related terminology may be found in much of the following description. However, those of ordinary skill in the art will recognize that one or more aspects of the present disclosure may be employed and included in one or more other wireless communication protocols and systems.

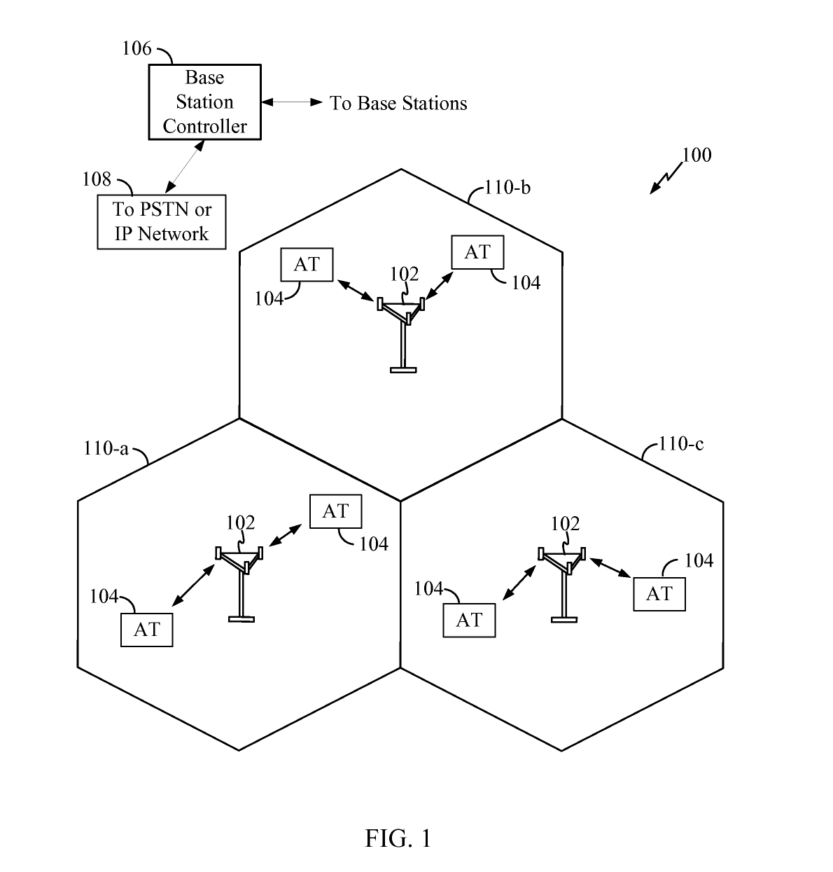

FIG. 1 is a block diagram illustrating an example of a network environment in which one or more aspects of the present disclosure may find application. The wireless communication system 100 generally includes one or more base stations 102, one or more access terminals 104, one or more base station controllers (BSC) 106, and a core network 108 providing access to a public switched telephone network (PSTN) (e.g., via a mobile switching center/visitor location register (MSC/VLR)) and/or to an IP network (e.g., via a packet data switching node (PDSN)). The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc.

The base stations 102 can wirelessly communicate with the access terminals 104 via a base station antenna. The base stations 102 may each be implemented generally as a device adapted to facilitate wireless connectivity (for one or more access terminals 104) to the wireless communications system 100. A base station 102 may also be referred to by those skilled in the art as an access point, a base transceiver station (BTS), a radio base station, a radio transceiver, a transceiver function, a basic service set (BSS), an extended service set (ESS), a Node B, a femto cell, a pico cell, and/or some other suitable terminology.

The base stations 102 are configured to communicate with the access terminals 104 under the control of the base station controller 106 via multiple carriers. Each of the base stations 102 can provide communication coverage for a respective geographic area. The coverage area 110 for each base station 102 here is identified as cells 110-a, 110-b, or 110-c. The coverage area 110 for a base station 102 may be divided into sectors (not shown, but making up only a portion of the coverage area). In a coverage area 110 that is divided into sectors, the multiple sectors within a coverage area 110 can be formed by groups of antennas with each antenna responsible for communication with one or more access terminals 104 in a portion of the cell.

One or more access terminals 104 may be dispersed throughout the coverage areas 110, and may wirelessly communicate with one or more sectors associated with each respective base station 102. An access terminal 104 may generally include one or more devices that communicate with one or more other devices through wireless signals. Such access terminals 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. The access terminals 104 may include mobile terminals and/or at least substantially fixed terminals. Examples of access terminals 104 include mobile phones, pagers, wireless modems, personal digital assistants, personal information managers (PIMs), personal media players, palmtop computers, laptop computers, tablet computers, televisions, appliances, e-readers, digital video recorders (DVRs), machine-to-machine (M2M) devices, and/or other communication/computing devices which communicate, at least partially, through a wireless or cellular network.

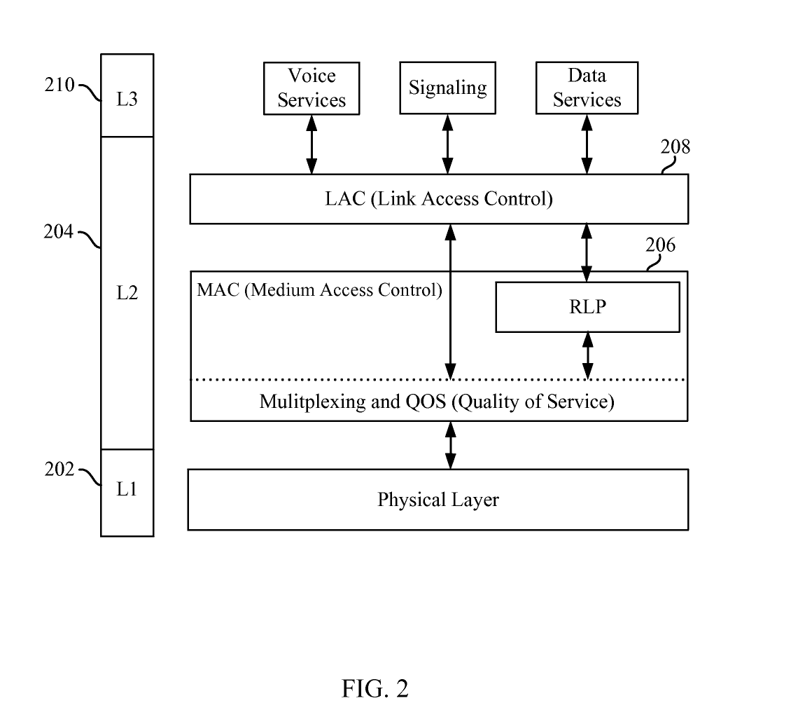

The access terminal 104 may be adapted to employ a protocol stack architecture for communicating data between the access terminal 104 and one or more network nodes of the wireless communication system 100 (e.g., the base station 102). A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base. FIG. 2 is a block diagram illustrating an example of a protocol stack architecture which may be implemented by an access terminal 104. Referring to FIGS. 1 and 2, the protocol stack architecture for the access terminal 104 is shown to generally include three layers: Layer 1 (L1), Layer 2 (L2), and Layer 3 (L3).

Layer 1 202 is the lowest layer and implements various physical layer signal processing functions. Layer 1 202 is also referred to herein as the physical layer 202. This physical layer 202 provides for the transmission and reception of radio signals between the access terminal 104 and a base station 102.

The data link layer, called layer 2 (or “the L2 layer”) 204 is above the physical layer 202 and is responsible for delivery of signaling messages generated by Layer 3. The L2 layer 204 makes use of the services provided by the physical layer 202. The L2 layer 204 may include two sublayers: the Medium Access Control (MAC) sublayer 206, and the Link Access Control (LAC) sublayer 208.

The MAC sublayer 206 is the lower sublayer of the L2 layer 204. The MAC sublayer 206 implements the medium access protocol and is responsible for transport of higher layers' protocol data units using the services provided by the physical layer 202. The MAC sublayer 206 may manage the access of data from the higher layers to the shared air interface.

The LAC sublayer 208 is the upper sublayer of the L2 layer 204. The LAC sublayer 208 implements a data link protocol that provides for the correct transport and delivery of signaling messages generated at the layer 3. The LAC sublayer makes use of the services provided by the lower layers (e.g., layer 1 and the MAC sublayer).

Layer 3 210, which may also be referred to as the upper layer or the L3 layer, originates and terminates signaling messages according to the semantics and timing of the communication protocol between a base station 102 and the access terminal 104. The L3 layer 210 makes use of the services provided by the L2 layer. Information (both data and voice) message are also passed through the L3 layer 210.

Referring again to FIG. 1, one or more of the access terminals 104 may be adapted to facilitate-packet switched data calls. For example, an access terminal 104 may be adapted to conduct a packet-switched data call employing a protocol and/or system implementing 3rd Generation Partnership Project 2 (3GPP2) 1× Advanced packet switched parameters. 3GPP2 1× Advanced builds on the 3GPP2 1× technology platform to enable increases to voice capacity of a network by using various interference cancellation and radio link enhancements, such as interference cancellation, improved power control, early frame termination, and smart blanking.

Smart blanking refers to use of a single background noise packet that can be reused until there is a significant change. For example, a user of an access terminal 104 may be accustomed to hearing some background noise in phone conversations. Instead of constantly sending background noise during silence periods, an access terminal 104 can transmit a background noise packet at the beginning of a silence period, and only update the background noise information when there is a significant change. The receiving device can repeatedly play back the last packet of background noise until a new packet is received. In some instances, an access terminal 104 transmits a guarantee frame during smart blanking periods. For instance, at least one non-blanked frame is sent by the access terminal 104 every ‘n’ number of frames, as negotiated by the network.

During a packet switched data call, an access terminal 104 may be adapted to enter a dormant mode when no data has been transmitted and/or received by the access terminal 104 for a period of time. This period of time is typically determined by a dormancy timer. When the access terminal 104 does not transmit and/or receive any packet data for an interval defined by the dormancy timer, the access terminal 104 will enter a dormant mode, and air resources reserved for the access terminal 104 will be released.

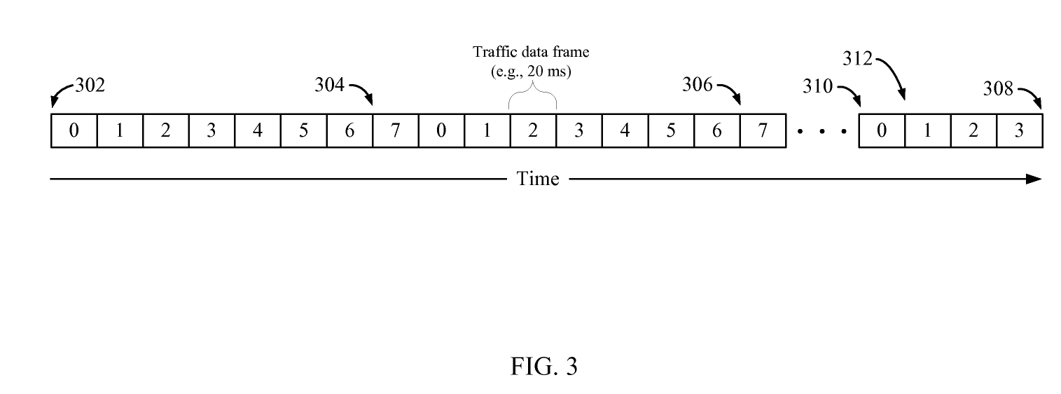

During the period of time from when the dormancy timer is initiated to the time when the dormancy timer is expired, the access terminal 104 may periodically transmit a guarantee frame according to a predefined cycle. For example, FIG. 3 is a block diagram illustrating a typical frame sequence in conventional access terminals. In the example illustrated, each frame may be about 20 milliseconds in duration, and the access terminal may be configured to send a guarantee frame in one (I) frame out of every eight (8) frames, although the actual duration of the frames and frequency of guarantee frames may vary according to different implementations. When there is no data to be sent, a dormancy timer may be initiated at 302. At each frame seven (7), a guarantee frame may be sent 304, 306, until the dormancy timer period expires at 308. When the dormancy timer expires without any data being transmitted and/or received (except for the guarantee frames, which do not affect the dormancy timer), the access terminal releases the air resources and suspends data traffic. During the duration of the dormancy timer, the access terminal's transmitter circuit remains powered on until the access terminal enters dormancy mode, even though there is no data to be sent and/or no data received by the access terminal.

If the access terminal 104 obtains data to be transmitted, for example at 310, then the access terminal 104 will transmit the data and the dormancy timer will be reset at, for example, 312. As a result, the access terminal 104 can remain actively connected even though there is limited transmission activity. Similarly, if the access terminal 104 receives infrequent data transmitted to the access terminal 104, then the dormancy timer may be reset in response to the received data. As a result, the access terminal 104 can remain actively connected even though there is limited reception activity.

According to at least one aspect of the disclosure, access terminals are adapted to facilitate power conservation by powering down the transmitter circuit when no data is transmitted for a specified period of time, but before the expiration of a dormancy timer. That is, access terminals are adapted to power down the transmitter circuit independent of the dormancy timer. Such features can result in the conservation of significant battery power of the access terminals. In at least some examples, these features can be implemented with programming employed at the L2 layer 204 and/or the physical layer 202, as well as upper layers of the protocol stack referred to above with reference to FIG. 2.

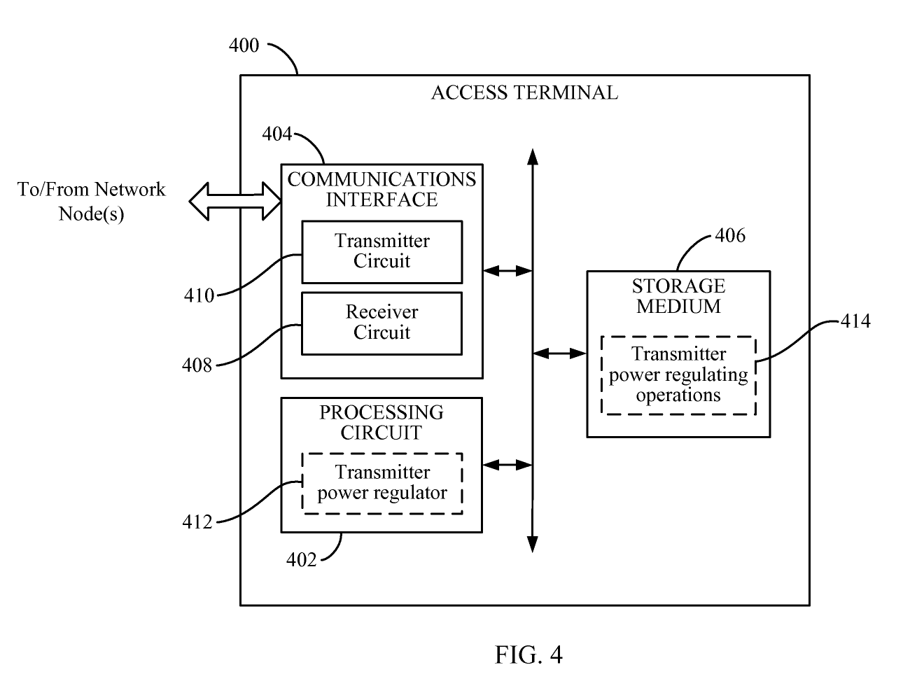

FIG. 4 is a block diagram illustrating select components of an access terminal 400 adapted to employ such features according to at least one example. The access terminal 400 may include a processing circuit 402 coupled to or placed in electrical communication with a communications interface 404 and a storage medium 406.

The processing circuit 402 is arranged to obtain, process and/or send data, control data access and storage, issue commands, and control other desired operations. The processing circuit 402 may include circuitry configured to implement desired programming provided by appropriate media in at least one example. For example, the processing circuit 402 may be implemented as one or more processors, one or more controllers, and/or other structure configured to execute executable programming. Examples of the processing circuit 402 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 402 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 402 are for illustration and other suitable configurations within the scope of the present disclosure are also contemplated.

The processing circuit 402 is adapted for processing, including the execution of programming, which may be stored on the storage medium 406. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 402 may include a transmitter power regulator 412. The transmitter power regulator 412 may include circuitry and/or programming adapted to monitor the transmitter 410, and regulate whether the transmitter 410 is powered on and off in response to intervals during which there is no data for transmission. Such powering on and off of the transmitter 410 is conducted independent of a dormancy timer.

The communications interface 404 is configured to facilitate wireless communications of the access terminal 400. For example, the communications interface 404 may include circuitry and/or programming adapted to facilitate the communication of information bi-directionally with respect to one or more network nodes. The communications interface 404 may be coupled to one or more antennas (not shown), and includes wireless transceiver circuitry, including at least one receiver circuit 408 (e.g., one or more receiver chains) and/or at least one transmitter circuit 410 (e.g., one or more transmitter chains). By way of example and not limitation, the at least one transmitter circuit 410 may include circuitry, devices and/or programming adapted to provide various signal conditioning functions including amplification, filtering, and modulating transmission frames onto a carrier for uplink transmission over a wireless medium through an antenna.

The storage medium 406 may represent one or more computer-readable, machine-readable, and/or processor-readable devices for storing programming, such as processor executable code or instructions (e.g., software, firmware), electronic data, databases, or other digital information. The storage medium 406 may also be used for storing data that is manipulated by the processing circuit 402 when executing programming. The storage medium 406 may be any available media that can be accessed by a general purpose or special purpose processor, including portable or fixed storage devices, optical storage devices, and various other mediums capable of storing, containing or carrying programming. By way of example and not limitation, the storage medium 406 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 406 may be coupled to the processing circuit 402 such that the processing circuit 402 can read information from, and write information to, the storage medium 406. That is, the storage medium 406 can be coupled to the processing circuit 402 so that the storage medium 406 is at least accessible by the processing circuit 402, including examples where the storage medium 406 is integral to the processing circuit 402 and/or examples where the storage medium 406 is separate from the processing circuit 402 (e.g., resident in the access terminal 400, external to the access terminal 400, distributed across multiple entities).

Programming stored by the storage medium 406, when executed by the processing circuit 402, causes the processing circuit 402 to perform one or more of the various functions and/or process steps described herein. For example, the storage medium 406 may include transmitter power regulating operations 414. The transmitter power regulating operations 414 can be implemented by the processing circuit 402 in, for example, the transmitter power regulator 412, to monitor the transmitter 410, and regulate whether the transmitter 410 is powered on and off in response to intervals during which there is no data for transmission. Thus, according to one or more aspects of the present disclosure, the processing circuit 402 is adapted to perform (in conjunction with the storage medium 406) any or all of the processes, functions, steps and/or routines for any or all of the access terminals described herein (e.g., access terminal 104). As used herein, the term “adapted” in relation to the processing circuit 402 may refer to the processing circuit 402 being one or more of configured, employed, implemented, and/or programmed to perform a particular process, function, step and/or routine according to various features described herein.

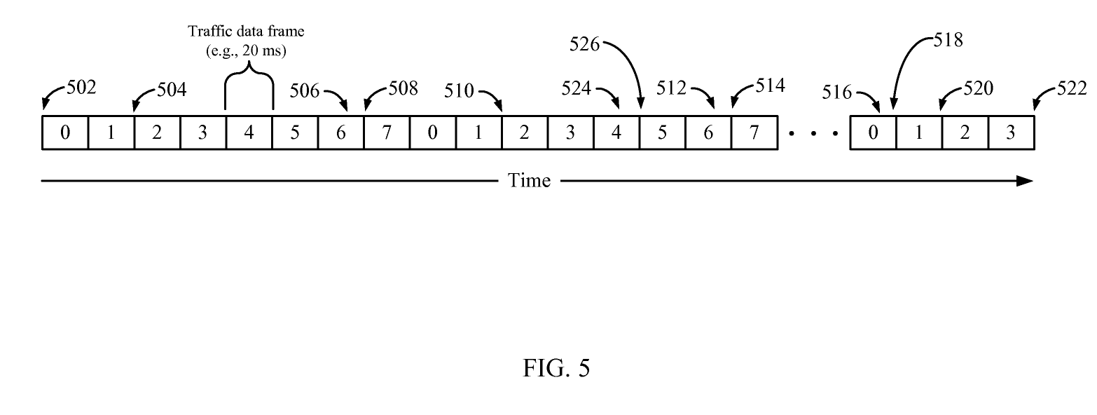

In operation, the access terminal 400 is adapted to manage the power to the transmitter circuit 410 independent of the dormancy timer by turning off the power to the transmitter circuit 410 when a predetermined period of time passes without data to be transmitted from the access terminal 400. FIG. 5 is a block diagram illustrating an operational frame sequence in an access terminal 400 according to at least one example. In the example illustrated, each frame may be about 20 milliseconds in duration, and the access terminal 400 may be configured to send a guarantee frame in one (I) frame out of every eight (8) frames, although the particular duration of each frame and frequency for each guarantee frame may vary according to various implementations.

With reference to FIGS. 4 and 5, the access terminal 400 may have no data to be sent at 502. In response to not having any data to send, the access terminal initiates a dormancy timer. In addition to the access terminal 400 initiating a dormancy timer at 502, the access terminal 400 may also keep track of the amount of time that passes without any data to be sent. For instance, the access terminal 400 may also set a transmitter power timer at 502 for a predetermined period of time. In the example illustrated in FIG. 5, the transmitter power timer may be set for a specified number of frames. By way of example and not limitation, the number of frames may include any number one (1) or above, depending on the specific implementation. For purposes of illustration and example only, the present example will be described with the transmitter power timer set for two (2) frames. Thus, after the passage of the predetermined period of time of two (2) frames without any data to be transmitted by the access terminal 400, the transmitter circuit 410 is powered down at 504.

Since the dormancy timer has not expired, the access terminal 400 will continue to send a guarantee frame according to the specified schedule. In this example, the access terminal 400 sends a guarantee frame every eighth (8^{th}) frame. The access terminal 400 will accordingly power up the transmitter circuit 410 some time prior to frame seven (7), as shown by arrow 506, and will send a guarantee frame at 508.

At the time of transmitting the guarantee frame, the transmitter power timer is reset, and the access terminal 400 monitors for another two (2) frames to determine whether there is data to be sent. If there is no data for the duration of the transmitter power timer, then the access terminal 400 powers down the transmitter circuit 410 at 510 (e.g., two frames after the frame in which the guarantee frame was transmitted). This process can continue during the duration of the dormancy timer. For instance, assuming no data is to be sent by the access terminal 400, the transmitter circuit 410 is powered on at 512 for transmitting the guarantee frame at 514. The transmitter circuit 410 can subsequently be powered down after two (2) frames when no data is to be sent by the access terminal 400.

If, at some time prior to the expiration of the dormancy timer, the access terminal 400 obtains data to be transmitted, then the transmitter circuit 410 can be powered on and the data can be transmitted. For example, at 516 a user may decide to send data using the access terminal 400. For instance, the user may send web data, or may send a chat message using a chat application (e.g., Google chat, Facebook chat, MSN chat, etc.). The access terminal 400 will power on the transmitter circuit 410 and will transmit the data at 518. After transmitting the data, the dormancy timer is re-initialized to the full duration of the timer at 520. For example, if the dormancy timer is 30 seconds, then the access terminal 400 will re-initialize the dormancy timer back to a full 30 seconds and begin counting down from there. Similarly, the transmitter power timer is also re-initialized at 520 after the data is transmitted at 518.

After the transmitter power timer expires, the access terminal 400 can determine a quantity of time remaining before the next guarantee frame is scheduled to be sent. If the amount of time is sufficient, the access terminal 400 may power down the transmitter circuit 410 after the duration of the transmitter power timer, as shown at 522. On the other hand, if the amount of time before the next guarantee frame is scheduled to be sent is below some threshold value, then the access terminal 400 may keep the transmitter circuit 410 powered up until after transmission of the guarantee frame.

In some instances, the access terminal 400 may receive a transmission in the forward link for which an acknowledgment message should be sent. For example, at 524 the access terminal 400 may identify valid data on the forward link for which an acknowledgment message is to be sent. As a result, the access terminal 400 may power on the transmitter circuit 410 and send the acknowledgment message at 524. With the transmitter circuit 410 powered on, the access terminal 400 can determine whether the amount of time before the next scheduled guarantee frame at 514 is greater than or less than the threshold value. If it is greater than the threshold value, the access terminal 400 can power off the transmitter circuit 410. If it is less than the threshold value, the access terminal 400 can keep the transmitter circuit 410 powered on until after the guarantee frame is transmitted at 514.

According to at least one feature, the access terminal 400 may be further adapted to efficiently use the guarantee frame slot (e.g., at 508 and 514) to send data transmissions. For example, when the access terminal 400 obtains data to be transmitted, such as the data at 516, the access terminal may determine the quantity of time remaining until the next guarantee frame. If the amount of time remaining is less than a predetermined threshold, the access terminal 400 may buffer the data and then transmit the data with the next guarantee frame. In this manner, the access terminal 400 may be able to power off the transmitter circuit 410 for even longer periods, increasing the power conservation at the access terminal 400.

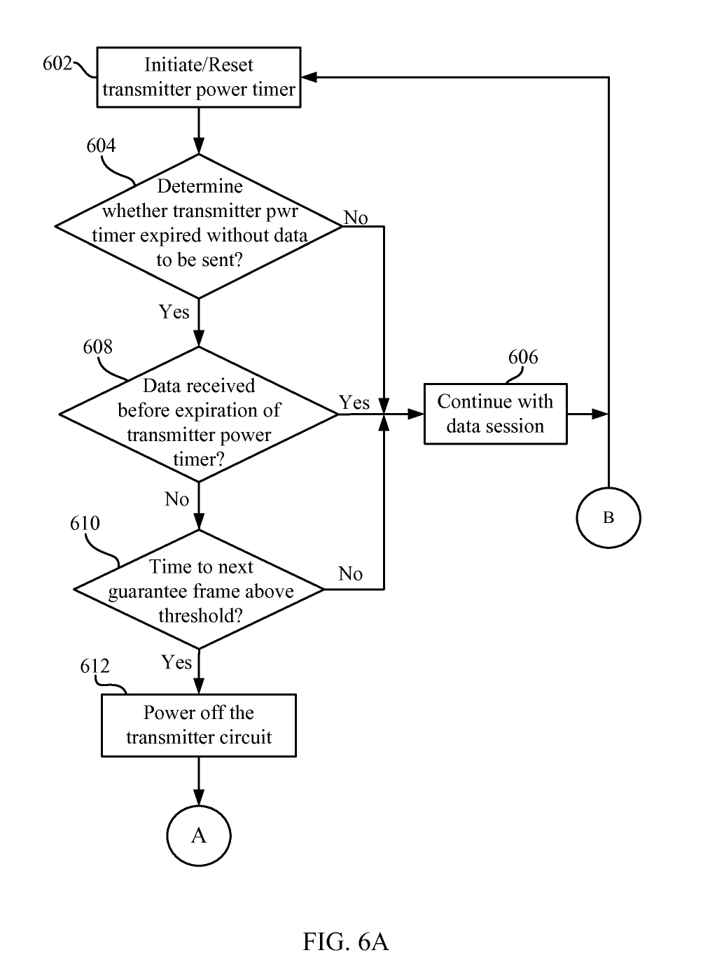

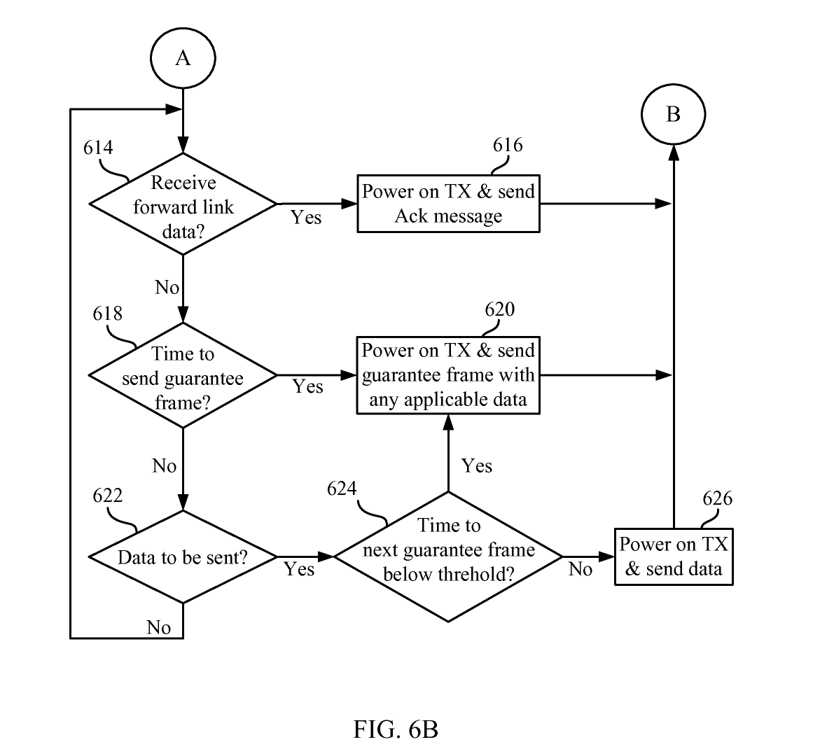

Turning to FIG. 6 (including FIGS. 6A and 6B), a flow diagram is shown illustrating at least one example of a method operational on an access terminal for facilitating transmitter power regulation. In this example, it is assumed that an access terminal 400 is operating in active mode where the access terminal 400 is conducting a packet switched data session. For example, the access terminal 400 may actively be wirelessly connected via the communications interface 404 with a network for communicating packet data between the network and the access terminal 400.

Referring initially to FIGS. 4 and 6A, the access terminal 400 may initiate a transmitter power timer following the transmission of data at step 602. For example, following the transmission of data, the processing circuit 402 (e.g., the transmitter power regulator 412) executing the transmitter power regulating operations 414 may initiate the transmitter power timer, to determine a length of time during which there is no data to be transmitted via the transmitter 410. The processing circuit 402 (e.g., the transmitter power regulator 412) executing the transmitter power regulating operations 414 may be adapted to reset the transmitter power timer each time after any data is transmitted by the transmitter circuit 410.

In at least some examples, the processing circuit 402 may also initiate a dormancy timer following the transmission of data. When the dormancy timer expires without any data other than guarantee frames being transmitted and/or without any data being received, the processing circuit 402 can enter into a dormant mode by, for example, releasing the air resources and suspending data traffic. The processing circuit 402 may also be adapted to reset the dormancy timer each time after data other than a guarantee frame is transmitted via the transmitter circuit 410.

At step 604, the access terminal 400 can determine whether a predetermined period of time has expired with no data to be sent. For example, the processing circuit 402 may determine whether a transmitter power timer has expired without any data to be sent via the transmitter circuit 410. In at least some examples, the transmitter power regulator 412 may execute the transmitter power regulating operations 414 to initiate the transmitter power timer and to determine whether the transmitter power timer has expired. By way of example and not limitation, the time period may be associated with a predetermined number (e.g., one or more) of data transmission frames. That is, the transmitter power timer may be adapted to expire after a predetermined number of data transmission frames have passed without any data available for transmission.

If the processing circuit 402 determines that the transmitter power timer has not expired, then the processing circuit 402 can continue with the active data session without powering down the transmitter circuit 410, as illustrated at step 606. If, on the other hand, the processing circuit 402 determines that the transmitter power timer has expired, then the access terminal 400 can further determine whether any data has been received during the duration of the transmitter power timer, at step 608. For example, the processing circuit 402 (e.g., the transmitter power regulator 412) implementing the transmitter power regulating operations 414 may monitor the communications interface 404 (e.g., the receiver circuit 408) to determine whether the access terminal 400 has received any data from the network or another wireless device. If the processing circuit 402 determines that data has been received during the duration of the transmitter power timer, the access terminal 400 can continue, at step 606, with the active data session without powering down the transmitter circuit 410.

At step 610, the access terminal 400 can determine whether the time until the next guarantee frame is less than or more than a predetermined threshold. For example, the processing circuit 402 (e.g., the transmitter power regulator 412) implementing the transmitter power regulating operations 414 may determine whether the time before the next guarantee frame is above the threshold value (e.g., two or more frames before the next guarantee frame when the threshold is one frame). If the time to the next guarantee frame is not above the threshold (e.g., there is less time before the next guarantee frame than defined by the threshold), then the access terminal 400 can continue with the active data session 606 without powering down the transmitter circuit 410. That is, when the quantity of time remaining before the next guarantee frame is scheduled to be transmitted is less than the threshold value, then the processing circuit 402 may keep the transmitter circuit 410 powered on even though the transmitter power timer has expired.

If the processing circuit 402 (e.g., the transmitter power regulator 412) determines that the predetermined period has passed without any data to be sent (step 604) and/or without any data being received (step 606), and/or that the time remaining before the next guarantee frame is above the threshold, then the access terminal 400 may power down the transmitter circuit 410, at step 612. For example, the processing circuit 402 (e.g., the transmitter power regulator 412) implementing the transmitter power regulating operations 414 may power off the transmitter circuit 410. Powering off the transmitter circuit 410 may include turning off the power supply and/or reducing the amount of power supplied to one or more components of the transmitter circuit 410 and/or one or more components adapted to operate in association with the transmitter circuit 410 (e.g., a transmit frame processor, a transmit processor etc.).

Referring now to FIGS. 4 and 6B, subsequent to powering off the transmitter circuit 410, the access terminal 400 may determine whether any forward link data is received, at step 614. For example, the processing circuit 402 (e.g., the transmitter power regulator 412) implementing the transmitter power regulating operations 414 may monitor the communications interface 404 (e.g., the receiver circuit 408) to determine whether any forward link data is received. If forward link data is received at step 614, the processing circuit 402 (e.g., the transmitter power regulator 412) implementing the transmitter power regulating operations 414 may power on the transmitter circuit 410 and send an acknowledgment message at step 616. In at least some examples, the acknowledgment message may be sent according to a frame early termination (FET) protocol, in which the acknowledgement is used to terminate transmission of a frame earlier than the nominal length of the frame, once the frame is successfully decoded by the access terminal. After sending the acknowledgement message, the access terminal 400 can return to step 602 shown in FIG. 6A, where the transmitter power timer can be reset in response to the transmission of data.

With the transmitter circuit 410 powered off, the access terminal 400 may also determine whether it is time to send a guarantee frame, at step 618. For example, the processing circuit 402 (e.g., the transmitter power regulator 412) implementing the transmitter power regulating operations 414 may monitor the frames to determine if a frame for transmitting a guarantee frame is approaching. If the time to send a guarantee frame is sufficiently near, the processing circuit 402 (e.g., the transmitter power regulator 412) implementing the transmitter power regulating operations 414 may power on the transmitter circuit 410 and send the guarantee frame at step 620. After sending the guarantee frame, the access terminal 400 can return to step 602 shown in FIG. 6A, where the transmitter power timer can be reset in response to the transmission of data.

With the transmitter circuit 410 powered off, the access terminal 400 may also determine whether there is any data to be sent at step 622. For instance, a user may prepare a chat message to send or may request internet data. When the access terminal 400 detects such data to be sent, the access terminal 400 may determine how much time remains before the next guarantee frame is to be sent, at step 624. For example, the processing circuit 402 (e.g., the transmitter power regulator 412) implementing the transmitter power regulating operations 414 may determine that data is available for transmission, and may determine the time remaining until the next guarantee frame. If the time remaining is below a predetermined threshold, then the processing circuit 402 (e.g., the transmitter power regulator 412) may buffer the data until the next guarantee frame. On arrival of the next guarantee frame, the processing circuit 402 can power on the transmitter circuit 410 and send the data at the same time as the guarantee frame, as indicated at step 620.

On the other hand, if the time remaining is above the predetermined threshold, then the processing circuit 402 (e.g., the transmitter power regulator 412) can power on the transmitter circuit 410 and send the data at step 626. After sending the data at step 626, the access terminal 400 can return to step 602 shown in FIG. 6A, where the transmitter power timer can be reset in response to the transmission of data.

If there is no forward link data received at step 614, if it is not time to send a guarantee frame at step 618, and if there is no data to be sent at step 622, the access terminal 400 may continue with the transmitter circuit 410 powered off.

One or more of the forgoing aspects and features may result in access terminals and/or methods that can efficiently employ a transmitter circuit in a manner to conserve power. By way of example and not limitation, these aspects and features may find application in instances where a user is sending data in discontinuous frames, resulting in substantial delay between data words (e.g., groups of valid data transmission frames) to the next data words (e.g., next group of valid data transmission frames). For instance, if a user sends a chat message (e.g., “Hi [symbol] ”) and then waits for a reply before sending a subsequent message (e.g., “how are you”), an access terminal of the present disclosure may be able to power off the transmitter circuit between sending or receiving valid data or for sending a guarantee frame. In at least one example, the average current consumed in an access terminal employing one or more aspects of the present disclosure was determined to be about 70 mA, while the average current consumed in a conventional access terminal was determined to be about 120 mA, resulting in power saving of about 50 mA.

While the above discussed aspects, arrangements, and embodiments are discussed with specific details and particularity, one or more of the components, steps, features and/or functions illustrated in FIGS. 1, 2, 3, 4, 5 and/or 6 may be rearranged and/or combined into a single component, step, feature or function or embodied in several components, steps, or functions. Additional elements, components, steps, and/or functions may also be added or not utilized without departing from the invention. The apparatus, devices and/or components illustrated in FIGS. 1 and/or 4 may be configured to perform or employ one or more of the methods, features, parameters, or steps described in FIGS. 2, 3, 5 and/or 6. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. An access terminal, comprising:
a communications interface including a transmitter circuit;
a storage medium; and
a processing circuit coupled to the transmitter circuit and the storage medium, the processing circuit adapted to:
identify expiration of a predetermined period of time without any data to be sent via the transmitter circuit; and
power down the transmitter circuit in response to the expiration of the predetermined period of time.

2. The access terminal of claim 1, wherein the processing circuit is further adapted to:
initiate a dormancy timer following a data transmission; and
enter a dormant mode when the dormancy timer is expired without transmitting data other than one or more guarantee frames.

3. The access terminal of claim 1, wherein the processing circuit is further adapted to:
power up the transmitter circuit; and
transmit a guarantee frame.

4. The access terminal of claim 1, wherein the processing circuit is further adapted to:
determine a quantity of time remaining after the expiration of the predetermined period of time before a guarantee frame is scheduled to be transmitted; and
keep the transmitter circuit powered up if the quantity of time remaining is less than a threshold value.

5. The access terminal of claim 1, wherein the processing circuit is further adapted to:
power up the transmitter circuit in response to data being available for transmission; and
send the data via the transmitter circuit.

6. The access terminal of claim 5, wherein the processing circuit is further adapted to:
determine that a quantity of time remaining until a next scheduled guarantee frame is below a threshold value;
buffer the available data while the transmitter circuit remains powered down; and
send the data via the transmitter circuit with the next scheduled guarantee frame.

7. The access terminal of claim 1, wherein the processing circuit is further adapted to:
receive data via the communications interface;
power up the transmitter circuit in response to the received data; and
send an acknowledgement message via the transmitter circuit in response to the received data.

8. The access terminal of claim 1, wherein the predetermined period of time without any data to be sent via the transmitter circuit comprises a predetermined number of frames without any data to be sent via the transmitter circuit.

9. A method operational on an access terminal, comprising:
initiating a transmitter power timer following a data transmission;
determining that the transmitter power timer has expired without data to be transmitted; and
powering off a transmitter circuit in response to the expiration of the transmitter power timer.

10. The method of claim 9, further comprising:
initiating a dormancy timer following the data transmission; and
entering a dormant mode when the dormancy timer is expired without transmitting data other than one or more guarantee frames.

11. The method of claim 9, further comprising:
powering on the transmitter circuit;
transmitting a guarantee frame; and
resetting the transmitter power timer following transmission of the guarantee frame.

12. The method of claim 9, further comprising:
after expiration of the transmitter power timer, determining a quantity of time remaining before a guarantee frame is scheduled to be transmitted; and
keeping the transmitter circuit powered on after expiration of the transmitter power timer when the quantity of time remaining before the guarantee frame is scheduled to be transmitted is less than a threshold value.

13. The method of claim 9, further comprising:
powering on the transmitter circuit in response to data being available for transmission; and
transmitting the available data.

14. The method of claim 13, further comprising:
determining that a quantity of time remaining until a next scheduled guarantee frame is below a threshold value;
buffering the data while the transmitter circuit remains powered off until the next scheduled guarantee frame; and
transmitting the available data with the next scheduled guarantee frame.

15. The method of claim 9, wherein determining that the transmitter power timer has expired without any data to be transmitted comprises:
identifying expiration of a predetermined number of frames without any data to be transmitted.

16. The method of claim 9, further comprising:
receiving a message including data;
powering on the transmitter circuit in response to the received data; and
sending an acknowledgement message in response to the received data.

17. An access terminal, comprising:
means for initiating a transmitter power timer following a data transmission;
means for determining that the transmitter power timer has expired without data to be transmitted; and
means for powering off a transmitter circuit in response to the expiration of the transmitter power timer.

18. The access terminal of claim 17, further comprising:
means for initiating a dormancy timer following the data transmission; and
means for entering a dormant mode when the dormancy timer is expired without transmitting data other than one or more guarantee frames.

19. The access terminal of claim 17, further comprising:
means for powering on the transmitter circuit;
means for transmitting a guarantee frame; and
means for resetting the transmitter power timer following transmission of the guarantee frame.

20. The access terminal of claim 17, further comprising:
means for determining a quantity of time from expiration of the transmitter power timer until a guarantee frame is scheduled to be transmitted; and
means for keeping the transmitter circuit powered on after expiration of the transmitter power timer when the quantity of time until the guarantee frame is scheduled to be transmitted is less than a threshold value.

21. A computer-readable storage medium, comprising programming for:
identifying expiration of a transmitter power timer without data to be transmitted; and
powering down a transmitter circuit in response to the expiration of the transmitter power timer.

22. The computer-readable storage medium of claim 21, further comprising programming for:
initiating a dormancy timer following a data transmission, wherein the dormancy timer is independent of the transmitter power timer; and
entering a dormant mode when the dormancy timer is expired without transmitting data other than one or more guarantee frames.

23. The computer-readable storage medium of claim 21, further comprising programming for:
powering up the transmitter circuit;
transmitting a guarantee frame; and
resetting the transmitter power timer following transmission of the guarantee frame.

24. The computer-readable storage medium of claim 21, further comprising programming for:
determining a quantity of time between expiration of the transmitter power timer and a scheduled transmission of a guarantee frame; and
keeping the transmitter circuit powered up after expiration of the transmitter power timer when the quantity of time until the scheduled transmission of the guarantee frame is less than a threshold value.

25. The computer-readable storage medium of claim 21, wherein identifying expiration of a transmitter power timer without data to be transmitted comprises:
identifying expiration of a predetermined number of frames without any data to be transmitted.

26. The computer-readable storage medium of claim 21, further comprising programming for:
determining that data is available for transmission after the transmitter circuit is power down
powering up the transmitter circuit; and
transmitting the available data.

27. The computer-readable storage medium of claim 26, further comprising programming for:
determining that a quantity of time remaining until a next scheduled guarantee frame is below a threshold value;
buffering the available data while the transmitter circuit remains powered down; and
sending the available data with the next scheduled guarantee frame.

28. The computer-readable medium of claim 21, wherein identifying expiration of the transmitter power timer without data to be transmitted comprises:
identifying expiration of a predetermined number of frames without any data to be transmitted.
